(19) United States
(12) Patent Application Publication
(10) Pub. No.: US 2013/0161424 A1
(43) Pub. Date: Jun. 27, 2013

(54) AUTOMATIC PAPER FEED SHREDDER

(71) Applicant: DONGGUAN FUTAI ELECTRONIC CO., LTD., Dongguan (CN)

(72) Inventor: Guofeng Pan, Dongguan (CN)

(73) Assignee: DONGGUAN FUTAI ELECTRONIC CO., LTD., Dongguan (CN)

(21) Appl. No.: 13/719,524

(22) Filed: Dec. 19, 2012

(30) Foreign Application Priority Data
Dec. 21, 2011 (CN) 201120539216.7

(51) Int. Cl. B02C 18/22

(52) U.S. Cl. CPC B02C 18/225
USPC 241/34

(57) ABSTRACT

The invention discloses an automatic paper feed shredder, which comprises a paper shredding device and an openable flip cover, wherein one side of the flip cover is hinged to the paper shredding device; the flip cover is disposed above the paper shredding device by covering; a paper placing platform and a paper inlet opening are disposed on the top of the paper shredding device; and at least one transmission belt gear assembly used for sucking paper into the paper shredding device for crushing is disposed on one side or both sides of the paper inlet opening. As the contact area between the transmission belt gear assembly (assemblies) and the paper is large, the friction force between the transmission belt gear assembly (assemblies) and the paper is large as well.

### FIELD OF THE INVENTION

The invention relates to the technical field of paper shredders, in particular to an automatic paper feed shredder.

### BACKGROUND OF THE INVENTION

In the prior art, due to the requirement of information privacy, paper shredders are produced for the enhancement of information privacy. However, in the case of a large amount of paper required to be shredded, users need to manually send documents and the like into the paper shredders, which wastes a lot of time, and consequently automatic paper feed shredders are produced.

As illustrated in FIG. 1, the automatic paper feed shredder is provided with a paper placing platform; a set of paper sucking shafts 1 are disposed on both sides of a paper inlet opening respectively; and a plurality of rubber wheels 2 are disposed on the paper sucking shafts 1. Paper at the bottom of the paper placing platform is winded into the paper inlet opening via the rotation of the rubber wheels 2, and then the automatic paper feed can be realized. However, as the contact area between the rubber wheels 2 and the paper is very small, the friction force between the rubber wheels 2 and the paper is very small as well, and thus the paper slips relative to the rubber wheels 2 in the case of automatic paper feed, and consequently the paper cannot be winded into the paper inlet opening. Therefore, the automatic paper feed shredder in the prior art must be improved.

### SUMMARY OF THE INVENTION

The objective of the invention is to overcome the defects in the prior art and provide an automatic paper feed shredder, which increases the friction force for paper winding, avoids the slipping phenomenon, and allows the paper winding process to be more stable and smoother in the case of automatic paper feed.

In order to achieve the objective, the invention adopts the technical proposal that:

The invention discloses an automatic paper feed shredder, which comprises a paper shredding device and an openable flip cover, wherein one side of the flip cover is hinged to the paper shredding device; the flip cover is disposed above the paper shredding device by covering; a paper placing platform and a paper inlet opening are disposed on the top of the paper shredding device; and at least one transmission belt gear assembly used for sucking paper into the paper shredding device for crushing and utilizing driving belts for paper winding is disposed on one side or both sides of the paper inlet opening.

The paper inlet opening is formed in the middle of the paper placing platform; and a transmission belt gear assembly is disposed on both sides of the paper inlet opening respectively.

A flip cover is disposed on both sides of the paper shredding device respectively; and a paper pressing mechanism is disposed at the bottom of each flip cover.

Each paper pressing mechanism has a paper pressing platform and at least one paper winding shaft which is disposed above the corresponding transmission belt gear assembly when the flip cover is disposed above the paper shredding device by covering.

Each transmission belt gear assembly has two transmission shafts and transmission belts driven by the transmission shafts; the transmission belts are sleeved on the two transmission shafts; and each transmission belt is provided with a paper sucking plane for sucking the paper into the paper shredding device for crushing.

The transmission belt gear assembly has synchronous transmission gears which are fixed on the transmission shafts; and both sides of transmission belt sleeves are disposed on the corresponding synchronous transmission gears respectively.

The transmission belt gear assembly has a plurality of transmission belts which are distributed at intervals along the axial direction of the transmission shafts.

The paper shredding device has a gear transmission system which is connected with the transmission shafts.

The transmission belts are synchronous transmission belts.

The automatic paper feed shredder adopting the technical proposal has the advantages that: as at least one transmission belt gear assembly used for sucking the paper into the paper shredding device for crushing is disposed on one side or both sides of the paper inlet opening of the automatic paper feed shredder, the contact area between the transmission belt gear assembly (assemblies) and the paper is large, and thus the friction force between the transmission belt gear assembly (assemblies) and the paper is large as well, and consequently the slipping phenomenon tends to not occur between the transmission belt gear assembly (assemblies) and the paper and the paper sucking operation tends to be easier. Therefore, the winding process of the shredder is more stable and smoother in the case of automatic paper feed.

### BRIEF DESCRIPTION OF THE DRAWINGS

FIG. 1 is a structure diagram of a paper sucking device for the automatic paper feed shredder in the prior art;

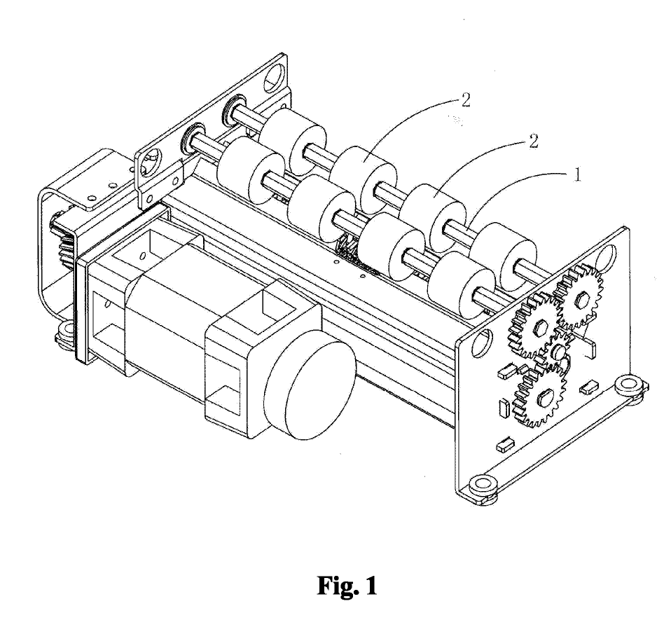

FIG. 2 is a structure diagram of the automatic paper feed shredder provided by the invention;

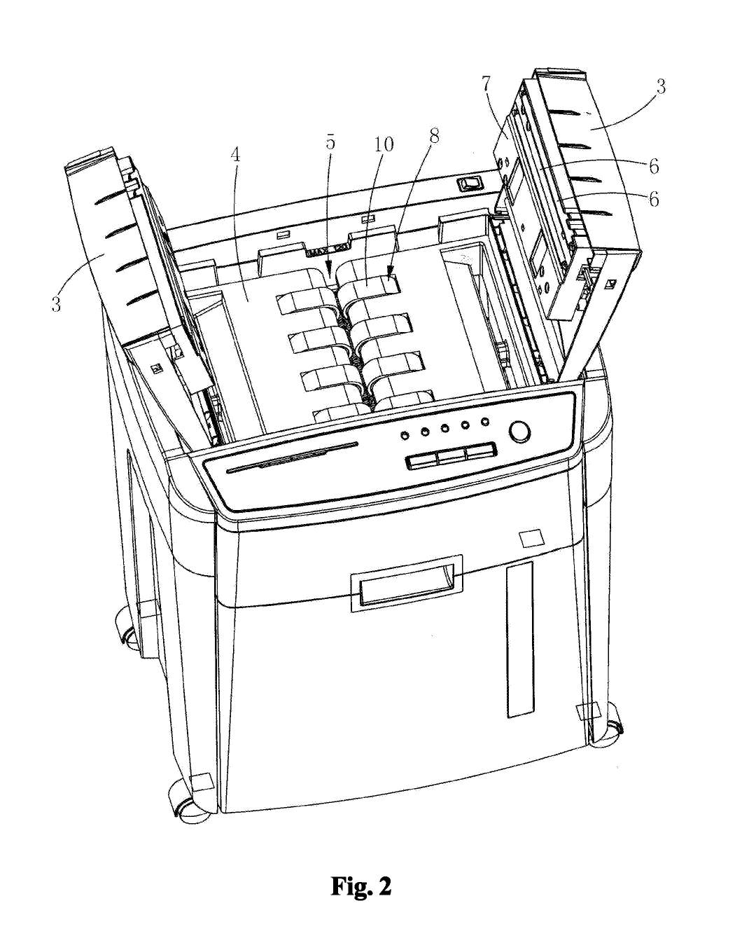

FIG. 3 is an inner structure diagram of the automatic paper feed shredder provided by the invention; and

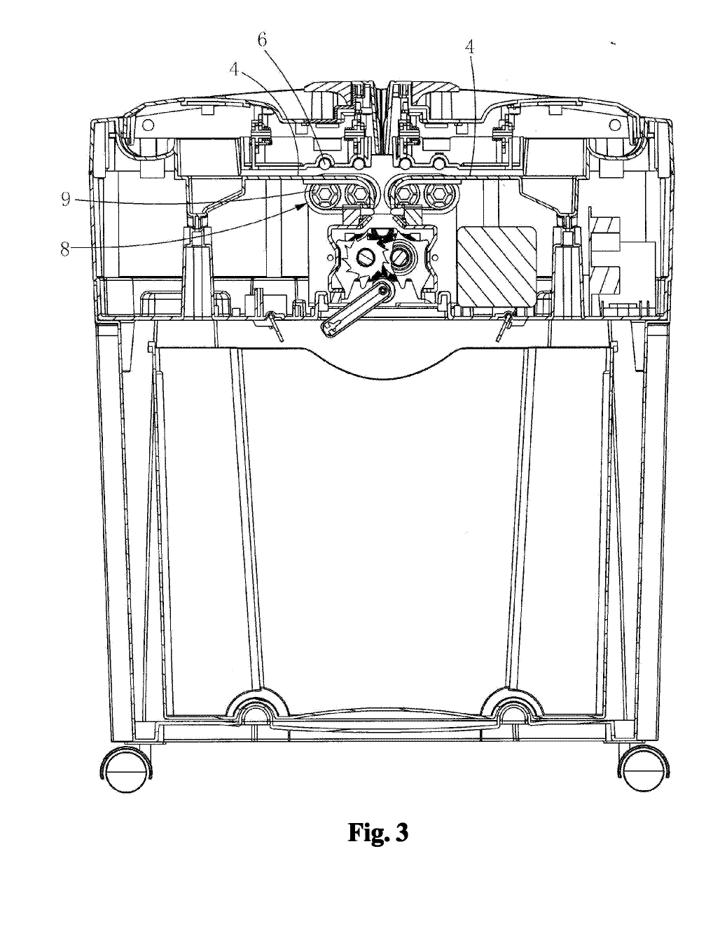

FIG. 4 is a structure diagram of a transmission belt gear assembly for the automatic paper feed shredder provided by the invention.

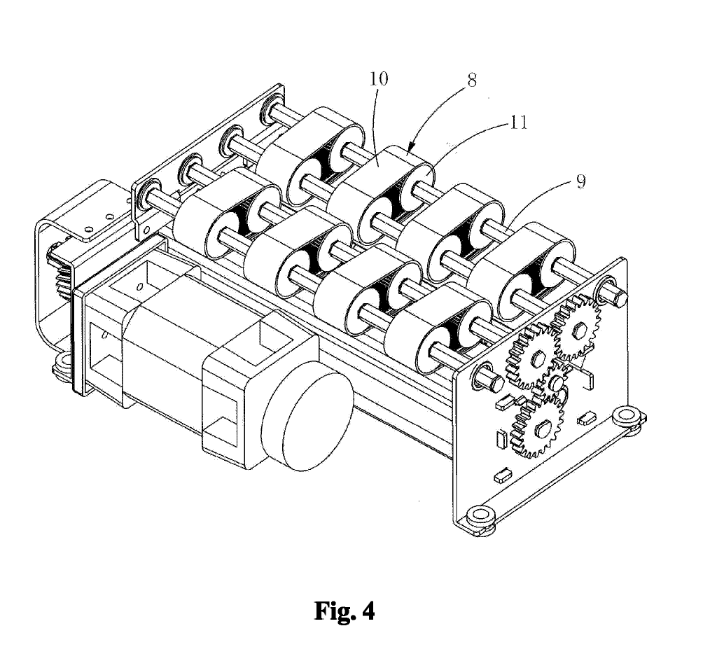

### DETAILED DESCRIPTION OF THE PREFERRED EMBODIMENTS

The invention discloses an automatic paper feed shredder, which comprises a paper shredding device and an openable flip cover 3, wherein one side of the flip cover 3 is hinged to the paper shredding device; the flip cover 3 is disposed above the paper shredding device by covering; a paper placing platform 4 and a paper inlet opening 5 are disposed on the top of the paper shredding device; the paper placing platform 4 is used for placing a stack of paper; and at least one transmission belt gear assembly is disposed on one side or both sides of the paper inlet opening 5 and used for utilizing transmission belts 8 for paper winding and sucking paper into the paper shredding device for crushing.

As the contact area between the transmission belt gear assembly (assemblies) and the paper is large, the friction force between the transmission belt gear assembly (assemblies) and the paper is large as well, and thus the slipping phenomenon tends to not occur between the transmission belt gear assembly (assemblies) and the paper and the paper sucking operation tends to be easier, and consequently the winding process of the shredder is more stable and smoother in the case of automatic paper feed.

The paper inlet opening 5 is formed in the middle of the paper placing platform 4; and a transmission belt gear assembly is disposed on both sides of the paper inlet opening respectively. Moreover, a flip cover 3 is disposed on both sides of the paper shredding device respectively, and a paper pressing mechanism is disposed at the bottom of each flip cover. Furthermore, each paper pressing mechanism has a paper pressing platform 7 and at least one paper winding shaft 6 which is disposed above the corresponding transmission belt gear assembly when the flip cover 3 is disposed above the paper shredding device by covering. And pressure is applied to the paper on the paper placing platform 4 by the paper pressing platform 7 of the flip cover 3.

Each transmission belt gear assembly has two transmission shafts 9 and the transmission belts 8 driven by the transmission shafts 9; the transmission belts 8 are sleeved on the two transmission shafts 9; and each transmission belt 8 is provided with a paper sucking plane 10 for sucking the paper into the paper shredding device for crushing. The paper sucking planes 10 are slightly higher than the paper placing platform 4. As the transmission belts 8 have specified length along the paper feed direction, the contact area between the transmission belts 8 and the paper is increased, and thus the friction force in the case of paper winding is increased.

The transmission belt gear assembly has synchronous transmission gears 11; the transmission belts 8 are synchronous transmission belts; the synchronous transmission gears 11 are fixed on the transmission shafts 9; and both sides of transmission belt sleeves are disposed on the corresponding synchronous transmission gears 11 respectively. Moreover, the transmission belt gear assembly has a plurality of transmission belts 8 which are distributed at intervals along the axial direction of the transmission shafts 9.

The paper shredding device has a gear transmission system which is connected with the transmission shafts 9.

The above illustrated is only the preferred embodiments of the invention. Changes can be made on the specific implementations and the application range by those skilled in the art on the basis of the concept of the invention. The content of the Description shall not be construed as a limit to the invention.

What is claimed is:

1. An automatic paper feed shredder, comprising a paper shredding device and an openable flip cover, wherein one side of the flip cover hinged to the paper shredding device; the flip cover disposed above the paper shredding device by covering; a paper placing platform and a paper inlet opening disposed on the top of the paper shredding device; and at least one transmission belt gear assembly used for sucking paper into the paper shredding device for crushing and utilizing transmission belts for paper winding disposed on one side or both sides of the paper inlet opening.

2. The automatic paper feed shredder according to claim 1, wherein each transmission belt gear assembly has two transmission shafts and transmission belts driven by the transmission shafts;
the transmission belts are sleeved on the two transmission shafts; and each transmission belt is provided with a paper sucking plane for sucking the paper into the paper shredding device for crushing.

3. The automatic paper feed shredder according to claim 2, wherein the transmission belt gear assembly has synchronous transmission gears which are fixed on the transmission shafts; and
both sides of transmission belt sleeves are disposed on the corresponding synchronous transmission gears respectively.

4. The automatic paper feed shredder according to claim 2, wherein the transmission belt gear assembly has a plurality of transmission belts which are distributed at intervals along the axial direction of the transmission shafts.

5. The automatic paper feed shredder according to claim 2, wherein the paper shredding device has a gear transmission system which is connected with the transmission shafts.

6. The automatic paper feed shredder according to claim 2, wherein the transmission belts are synchronous transmission belts.

7. The automatic paper feed shredder according to claim 1, wherein the paper inlet opening is formed in the middle of the paper placing platform; and a transmission belt gear assembly is disposed on both sides of the paper inlet opening respectively.

8. The automatic paper feed shredder according to claim 7, wherein each transmission belt gear assembly has two transmission shafts and transmission belts driven by the transmission shafts; the transmission belts are sleeved on the two transmission shafts; and each transmission belt is provided with a paper sucking plane for sucking the paper into the paper shredding device for crushing.

9. The automatic paper feed shredder according to claim 8, wherein the transmission belt gear assembly has synchronous transmission gears which are fixed on the transmission shafts; and both sides of transmission belt sleeves are disposed on the corresponding synchronous transmission gears respectively.

10. The automatic paper feed shredder according to claim 8, wherein the transmission belt gear assembly has a plurality of transmission belts which are distributed at intervals along the axial direction of the transmission shafts.

11. The automatic paper feed shredder according to claim 8, wherein the paper shredding device has a gear transmission system which is connected with the transmission shafts.

12. The automatic paper feed shredder according to claim 8, wherein the transmission belts are synchronous transmission belts.

13. The automatic paper feed shredder according to claim 2, wherein a flip cover is disposed on both sides of the paper shredding device respectively; and a paper pressing mechanism is disposed at the bottom of each flip cover.

14. The automatic paper feed shredder according to claim 13, wherein each transmission belt gear assembly has two transmission shafts and transmission belts driven by the transmission shafts; the transmission belts are sleeved on the two transmission shafts; and each transmission belt is provided with a paper sucking plane for sucking the paper into the paper shredding device for crushing.

15. The automatic paper feed shredder according to claim 14, wherein the transmission belt gear assembly has synchronous transmission gears which are fixed on the transmission shafts; and both sides of transmission belt sleeves are disposed on the corresponding synchronous transmission gears respectively.

16. The automatic paper feed shredder according to claim 14, wherein the transmission belt gear assembly has a plurality of transmission belts which are distributed at intervals along the axial direction of the transmission shafts.

17. The automatic paper feed shredder according to claim 14, wherein the paper shredding device has a gear transmission system which is connected with the transmission shafts.

18. The automatic paper feed shredder according to claim 14, wherein the transmission belts are synchronous transmission belts.

19. The automatic paper feed shredder according to claim 3, wherein each paper pressing mechanism has a paper pressing platform and at least one paper winding shaft which is disposed above the corresponding transmission belt gear assembly when the flip cover is disposed above the paper shredding device by covering.

20. The automatic paper feed shredder according to claim 19, wherein each transmission belt gear assembly has two transmission shafts and transmission belts driven by the transmission shafts; the transmission belts are sleeved on the two transmission shafts; and each transmission belt is provided with a paper sucking plane for sucking the paper into the paper shredding device for crushing.

21. The automatic paper feed shredder according to claim 20, wherein the transmission belt gear assembly has synchronous transmission gears which are fixed on the transmission shafts; and both sides of transmission belt sleeves are disposed on the corresponding synchronous transmission gears respectively.

22. The automatic paper feed shredder according to claim 20, wherein the transmission belt gear assembly has a plurality of transmission belts which are distributed at intervals along the axial direction of the transmission shafts.

23. The automatic paper feed shredder according to claim 20, wherein the paper shredding device has a gear transmission system which is connected with the transmission shafts.

24. The automatic paper feed shredder according to claim 20, wherein the transmission belts are synchronous transmission belts.
